(19) United States
(12) Patent Application Publication
(10) Pub. No.: US 2026/0244932 A1
(43) Pub. Date: Aug. 20, 2026

(54) SYSTEM AND METHOD FOR AMALGAMATION OF MULTI-MODAL AI PLATFORM DATA VIA DIGITAL DNA SYNTHESIS AND ANALYSIS TO PREVENT DISCREPANCIES

(71) Applicant: BANK OF AMERICA CORPORATION, Charlotte, NC (US)

(72) Inventors: Rajalakshmi Arumugam, Chennai (IN); Anusha Balasubramanian, Chennai (IN); Malini Jeyaseelan, Chennai (IN); Vishnurupa Nemili Ramachandran, Chennai (IN); Mallapragada Nagaharini, Gannavaram (IN)

(73) Assignee: BANK OF AMERICA CORPORATION, Charlotte, NC (US)

(21) Appl. No.: 19/055,282

(22) Filed: Feb. 17, 2025

(51) Int. Cl. G06N 3/086; G06N 3/042

(52) U.S. Cl. CPC G06N 3/086; G06N 3/042

(57) ABSTRACT

Systems, computer program products, and methods are described herein for amalgamation of multi-modal AI platform data via digital DNA synthesis and analysis to prevent discrepancies. The present disclosure includes receiving a plurality of applications for integration, scanning each application for elements, extracting embedded transformations from a fusion process used to create each respective application, identifying portions adversarial to other applications of the plurality of applications, extracting conflicting operational limits between each application, generating a plurality of digital genetic code sequences, combining corresponding digital genetic code sequences to form a digital genetic strand for each respective application, comparing each digital genetic strand to one another to result in generation of a first matrix comprising compatible sequences, converting the compatible sequences into binary data segments, and merging the binary data segments into a single unified application through an AI-assisted merger module.

### TECHNOLOGICAL FIELD

Example implementations of the present disclosure relate to a system and method for amalgamation of multi-modal AI platform data via digital DNA synthesis and analysis to prevent discrepancies.

### BACKGROUND

In the landscape of corporate growth and restructuring, mergers and acquisitions activities involve the integration of diverse Information Technology (“IT”) systems from the merging entities. As entities increasingly adopt multi-modal application platforms that leverage advanced artificial intelligence (“AI”)/machine learning (“ML”), large language models (“LLMs”), and generative models to support various operational domains, the complexity of merging these sophisticated systems escalates. Oftentimes, this complexity leads to one multi-modal application being completely abandoned in favor of a multi-modal application one of the entities in the merger. In doing so, techniques are often lost that could prove beneficial for the combined entity after merger occurs. Thus, to comfortably facilitate the use of some of these multi-modal applications, it must be ensured that the integrated IT infrastructure maintains high standards of data integrity, security, and operational efficiency. Accordingly, there exists a need for systems and methods for amalgamation of multi-modal AI platform data via digital DNA synthesis and analysis to prevent discrepancies.

### BRIEF SUMMARY

Systems, methods, and computer program products are provided for amalgamation of multi-modal AI platform data via digital DNA synthesis and analysis to prevent discrepancies.

In one aspect, a system for amalgamation of multi-modal AI platform data via digital DNA synthesis and analysis to prevent discrepancies is presented. The system may include a processing device, and a non-transitory storage device containing instructions, when executed by the processing device, the instructions cause the processing device to perform the steps of receiving a plurality of applications for integration to form a merged application, wherein each application of the plurality of applications may include a corresponding multi-modal AI application, scanning each application of the plurality of applications for elements, wherein the elements are selected from the group consisting of code, tensors, APIs, vector databases, fusion modules, and resource managers, extracting, for each application of the plurality of applications, by using a metaheuristic algorithm, embedded transformations from a fusion process used to create each respective application, identifying, in each application of the plurality of applications, by using a Tensor-based Gated Graph Neural Network, portions adversarial to other applications of the plurality of applications, extracting, from each application of the plurality of applications, by using multi-dimensional slicing, conflicting operational limits between each application of the plurality of applications, generating a plurality of digital genetic code sequences for each application of the plurality of applications, the plurality of digital genetic code sequences having digital code sequences representing the elements, the embedded transformations, the portions adversarial to each other, and the conflicting operational limits for each respective application, combining, for each application of the plurality of applications, corresponding digital genetic code sequences to form a digital genetic strand representing each respective application, resulting in a plurality of digital genetic strands, comparing, using a graph retrieval-augmented generation algorithm, each digital genetic strand of the plurality of genetic strands to one another to result in generation of a first matrix having compatible sequences, converting the compatible sequences of the first matrix into binary data segments, and merging the binary data segments into a single unified application through an AI-assisted merger module.

In some implementations, the instructions may further cause the processing device to perform the steps of comparing, using the graph retrieval-augmented generation algorithm, each digital genetic strand of the plurality of genetic strands to one another to result in generation of a second matrix having non-compatible sequences, determining, through genetic algorithms having fitness and selection functions, solutions to conflicts in the second matrix, remediating the conflicts of the second matrix through the solutions to the conflicts, and converting the remediated second matrix into corresponding binary data segments.

In some implementations, the instructions may further cause the processing device to perform the steps of comparing, using the graph retrieval-augmented generation algorithm, each digital genetic strand of the plurality of genetic strands to one another to result in generation of a third matrix having partially-compatible sequences, converting, using a codon optimizer algorithm, sequences of the third matrix into alternative sequences that are more compatible with the sequences in the first and second digital genetic strands, and converting the alternative sequences of the third matrix into corresponding binary data segments.

In some implementations, generating the corresponding digital genetic code sequences includes applying a predefined mapping of binary code segments to quaternary digital sequences.

In some implementations, comparing, using the graph retrieval-augmented generation algorithm, each digital genetic strand to one another may include constructing reference adjacency graphs identify compatible sequences.

In some implementations, the instructions may further cause the processing device to perform the steps of determining, using a model classifier, a model classification for each application of the plurality of applications, and generating a digital genetic code sequence for each application of the plurality of applications representing the model classification.

In some implementations, each digital genetic strand of the plurality of digital genetic strands may include a respective digital genetic code sequence representing the model classification for the respective application.

In another aspect, a computer program product for amalgamation of multi-modal AI platform data via digital DNA synthesis and analysis to prevent discrepancies is presented. The computer program product may a non-transitory computer-readable medium having code causing an apparatus to receive a plurality of applications for integration to form a merged application, wherein each application of the plurality of applications may include a corresponding multi-modal AI application, scan each application of the plurality of applications for elements, wherein the elements are selected from the group consisting of code, tensors, APIs, vector databases, fusion modules, and resource managers, extract, for each application of the plurality of applications, by using a metaheuristic algorithm, embedded transformations from a fusion process used to create each respective application, identify, in each application of the plurality of applications, by using a Tensor-based Gated Graph Neural Network, portions adversarial to other applications of the plurality of applications, extract, from each application of the plurality of applications, by using multi-dimensional slicing, conflicting operational limits between each application of the plurality of applications, generate a plurality of digital genetic code sequences for each application of the plurality of applications, the plurality of digital genetic code sequences having digital code sequences representing the elements, the embedded transformations, the portions adversarial to each other, and the conflicting operational limits for each respective application, combine, for each application of the plurality of applications, corresponding digital genetic code sequences to form a digital genetic strand representing each respective application, resulting in a plurality of digital genetic strands, compare, using a graph retrieval-augmented generation algorithm, each digital genetic strand of the plurality of genetic strands to one another to result in generation of a first matrix having compatible sequences, convert the compatible sequences of the first matrix into binary data segments, and merge the binary data segments into a single unified application through an AI-assisted merger module.

In some implementations, the code may further cause the apparatus to compare, using the graph retrieval-augmented generation algorithm, each digital genetic strand of the plurality of genetic strands to one another to result in generation of a second matrix having non-compatible sequences, determine, through genetic algorithms having fitness and selection functions, solutions to conflicts in the second matrix, remediate the conflicts of the second matrix through the solutions to the conflicts, and convert the remediated second matrix into corresponding binary data segments.

In some implementations, the code may further cause the apparatus to compare, using the graph retrieval-augmented generation algorithm, each digital genetic strand of the plurality of genetic strands to one another to result in generation of a third matrix having partially-compatible sequences, convert, using a codon optimizer algorithm, sequences of the third matrix into alternative sequences that are more compatible with the sequences in the first and second digital genetic strands, and convert the alternative sequences of the third matrix into corresponding binary data segments.

In some implementations, generating the corresponding digital genetic code sequences includes applying a predefined mapping of binary code segments to quaternary digital sequences.

In some implementations, comparing, using the graph retrieval-augmented generation algorithm, each digital genetic strand to one another may include constructing reference adjacency graphs identify compatible sequences.

In some implementations, the code may further cause the apparatus to determine, using a model classifier, a model classification for each application of the plurality of applications, and generate a digital genetic code sequence for each application of the plurality of applications representing the model classification.

In some implementations, each digital genetic strand of the plurality of digital genetic strands may include a respective digital genetic code sequence representing the model classification for the respective application.

In yet another aspect, a method for amalgamation of multi-modal AI platform data via digital DNA synthesis and analysis to prevent discrepancies is presented. The method may include receiving a plurality of applications for integration to form a merged application, wherein each application of the plurality of applications may include a corresponding multi-modal AI application, scanning each application of the plurality of applications for elements, wherein the elements are selected from the group consisting of code, tensors, APIs, vector databases, fusion modules, and resource managers, extracting, for each application of the plurality of applications, by using a metaheuristic algorithm, embedded transformations from a fusion process used to create each respective application, identifying, in each application of the plurality of applications, by using a Tensor-based Gated Graph Neural Network, portions adversarial to other applications of the plurality of applications, extracting, from each application of the plurality of applications, by using multi-dimensional slicing, conflicting operational limits between each application of the plurality of applications, generating a plurality of digital genetic code sequences for each application of the plurality of applications, the plurality of digital genetic code sequences having digital code sequences representing the elements, the embedded transformations, the portions adversarial to each other, and the conflicting operational limits for each respective application, combining, for each application of the plurality of applications, corresponding digital genetic code sequences to form a digital genetic strand representing each respective application, resulting in a plurality of digital genetic strands, comparing, using a graph retrieval-augmented generation algorithm, each digital genetic strand of the plurality of genetic strands to one another to result in generation of a first matrix having compatible sequences, converting the compatible sequences of the first matrix into binary data segments, and merging the binary data segments into a single unified application through an AI-assisted merger module.

In some implementations, the method may further include comparing, using the graph retrieval-augmented generation algorithm, each digital genetic strand of the plurality of genetic strands to one another to result in generation of a second matrix having non-compatible sequences, determining, through genetic algorithms having fitness and selection functions, solutions to conflicts in the second matrix, remediating the conflicts of the second matrix through the solutions to the conflicts, and converting the remediated second matrix into corresponding binary data segments.

In some implementations, the method may further include comparing, using the graph retrieval-augmented generation algorithm, each digital genetic strand of the plurality of genetic strands to one another to result in generation of a third matrix having partially-compatible sequences, converting, using a codon optimizer algorithm, sequences of the third matrix into alternative sequences that are more compatible with the sequences in the first and second digital genetic strands, and converting the alternative sequences of the third matrix into corresponding binary data segments.

In some implementations, wherein generating the corresponding digital genetic code sequences includes applying a predefined mapping of binary code segments to quaternary digital sequences.

In some implementations, comparing, using the graph retrieval-augmented generation algorithm, each digital genetic strand to one another may include constructing reference adjacency graphs identify compatible sequences.

In some implementations, the method may further include determining, using a model classifier, a model classification for each application of the plurality of applications, and generating a digital genetic code sequence for each application of the plurality of applications representing the model classification.

The above summary is provided merely for purposes of summarizing some example implementations to provide a basic understanding of some aspects of the present disclosure. Accordingly, it will be appreciated that the above-described implementations are merely examples and should not be construed to narrow the scope or spirit of the disclosure in any way. It will be appreciated that the scope of the present disclosure encompasses many potential implementations in addition to those here summarized, some of which will be further described below.

### BRIEF DESCRIPTION OF THE DRAWINGS

Having thus described implementations of the disclosure in general terms, reference will now be made the accompanying drawings. The components illustrated in the Figures may or may not be present in certain implementations described herein. Some implementations may include fewer (or more) components than those shown in the Figures.

FIGS. 1A-1C illustrate technical components of an exemplary distributed computing environment for amalgamation of multi-modal AI platform data via digital DNA synthesis and analysis to prevent discrepancies, in accordance with implementations of the disclosure;

FIG. 2 illustrates an exemplary machine learning model subsystem architecture, in accordance with implementations of the disclosure;

FIG. 3 illustrates a process flow for amalgamation of multi-modal AI platform data via digital DNA synthesis and analysis to prevent discrepancies, in accordance with implementations of the disclosure;

FIG. 4 illustrates a scenario ecosystem flow for amalgamation of multi-modal AI platform data via digital DNA synthesis and analysis to prevent discrepancies, in accordance with implementations of the disclosure; and

FIG. 5 illustrates an alternative process flow for amalgamation of multi-modal AI platform data via digital DNA synthesis and analysis to prevent discrepancies, in accordance with implementations of the disclosure.

### DETAILED DESCRIPTION

Implementations of the present disclosure will now be described more fully hereinafter with reference to the accompanying drawings, in which some, but not all, implementations of the disclosure are shown. Indeed, the disclosure may be implemented in many different forms and should not be construed as limited to the implementations set forth herein; rather, these implementations are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” may be also used herein. Furthermore, when it may be said herein that something may be “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the entity, its products or applications, the customers or any other aspect of the operations of the entity. As such, the entity may be any institution, group, association, financial institution, establishment, company, union, authority or the like, employing information technology resources for processing large amounts of data.

As described herein, a “user” may be an individual associated with an entity. As such, in some implementations, the user may be an individual having past relationships, current relationships or potential future relationships with an entity. In some implementations, the user may be an employee (e.g., an associate, a project manager, an IT specialist, a manager, an administrator, an internal operations analyst, or the like) of the entity or enterprises affiliated with the entity.

As used herein, a “user interface” or “display” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of a computer program, or part of a computer program that serves as a foundation for a larger piece of software and drives the functionality of the software. The term “engine” may be used herein interchangeably with “module” or “model”. An engine may be self-contained, but externally controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some implementations, an engine may be configured to retrieve resources created in other computer programs, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system. In some implementations, an engine may implement a machine learning model or generative AI model to perform functions as a foundation for the larger piece of software that drives the functionality of the software. The machine learning model or generative AI model for any given engine may be self-contained (e.g., without interaction with other engines), or the machine learning model or generative AI model may be shared across one or more engines. In other words, some implementations of the larger piece of software many implement multiple machine learning models or generative AI models to perform functions of the various engines. In other implementations, a single machine learning model or generative AI model may be shared across one or more engines to perform the functions attributed thereto as described herein.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

It should be understood that the word “exemplary” may be used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that an element matches a predetermined criterion, including that a threshold has been met, passed, exceeded, and so on.

When entities undergo mergers, particularly those with robust multi-modal AI/ML systems, significant technical challenges arise in integrating models with diverse data modalities such as text, images, video, and audio. For instance, entities merging their IT infrastructures must consolidate different AI-driven platforms that support domains like mortgage processing or retail services. A primary concern in this integration process is the chance of data poisoning, where malicious or corrupt data from either entity could compromise the entire merged system. Additionally, it is important to ensure that the model rules and algorithms from both the incoming and acquiring sides are harmonized without being misclassified as harmful. Maintaining stringent controls and guardrails across varied platforms is important to preserve data integrity and security throughout the merger, while also ensuring that the combined systems remain unambiguous, compatible, robust, and scalable.

Existing solutions for integrating IT systems during mergers typically involve manual consolidation processes or the use of generic data integration tools. However, these approaches often fall short when dealing with the complexities of multi-modal AI/ML systems. For example, traditional methods may struggle to effectively merge vectorized data and align different data embeddings without redundancy, leading to inefficiencies and potential security vulnerabilities. Current integration practices may not adequately address the specific needs of combining advanced AI applications that service overlapping domains, resulting in fragmented systems that are neither fully compatible nor scalable. This gap highlights a significant unmet need for specialized integration methodologies that can securely and efficiently unify multi-modal AI/ML platforms and ensure seamless operation and safeguarding against data corruption during the merger process.

Thus, addressing these challenges requires the establishment of a system and method for amalgamation of multi-modal AI platform data via digital DNA synthesis and analysis to prevent discrepancies, which provides for integration of disparate AI applications by encoding their operational data into digital genetic strands. This framework uses machine learning model(s) to enable efficient analysis, optimization, and integration of multi-modal data, to ensure compatibility, conflict resolution, and improved performance across interconnected AI applications.

To do so, the present disclosure allows for the integration of multiple AI applications by analyzing and synthesizing their data as digital genetic strands, which represent the internal structures and functionalities of each application. First, the system may scan each application for components such as code, tensors, APIs, and other operational elements. It then may use advanced algorithms, including metaheuristics and neural networks, to identify embedded transformations, detect adversarial portions, and extract conflicting operational limits. These findings may be encoded into unique digital genetic sequences that represent each application's attributes. The system may then combine these sequences into strands and use a graph-based algorithm to compare the strands, identifying compatible, non-compatible, and partially compatible segments. Compatible segments may be merged into a unified application, while conflicts may be resolved using genetic algorithms. For partially compatible segments, the system may apply algorithms to create alternative sequences for smoother integration. For non-compatible segments, the system may decode the sequences to characteristic determinants. An AI-assisted merger module may be implemented to then generate a single, unified multi-modal framework using the output from one or more of the matrices previously generated.

What is more, the present disclosure provides a technical solution to a technical problem. As described herein, the technical problem includes the inability to integrate multi-modal AI platform data as a result of compatibility issues. The present disclosure embraces an improvement over existing solutions by integrating multi-modal AI platform data (i) with fewer steps to achieve the solution (e.g., automated encoding of application data into digital genetic strands instead of manual compatibility checks), thus reducing the amount of network resources, such as processing resources, storage resources, network resources, and/or the like, that are being used, (ii) providing a more accurate solution to problem, thus reducing the number of resources required to remedy any errors made due to a less accurate solution (e.g., identifying compatibility issues and resolving conflicts using graph-based algorithms and genetic optimization techniques), (iii) removing manual input and waste from the implementation of the solution, thus improving speed and efficiency of the process and conserving network resources (e.g., automated conflict resolution and transformation optimization without human intervention), (iv) determining an optimal amount of resources that need to be used to implement the solution, thus reducing network traffic and load on existing network resources (e.g., adaptive allocation of computational resources for compatibility analysis and synthesis). In other words, the solution may bypass a series of steps previously implemented, thus further conserving network resources. Furthermore, the technical solution described herein uses a rigorous, computerized process to perform specific tasks and/or activities that were not previously performed.

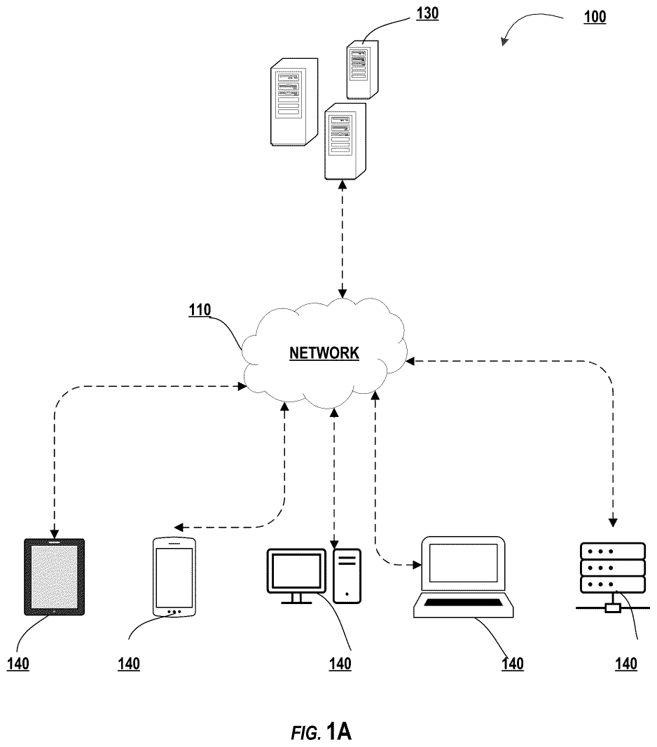

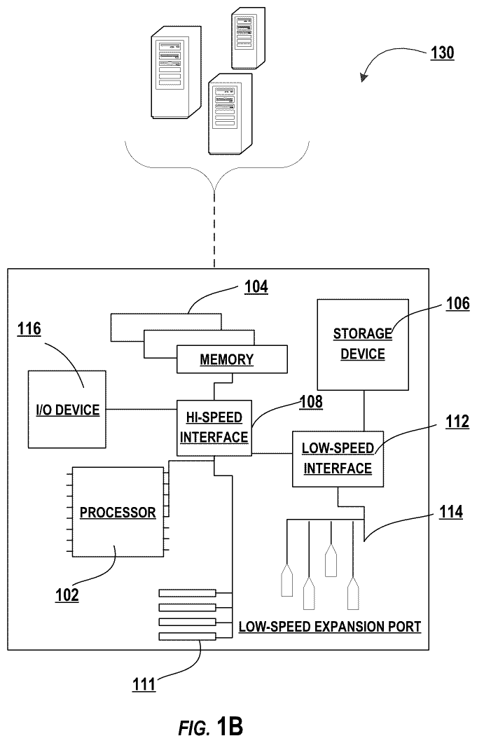

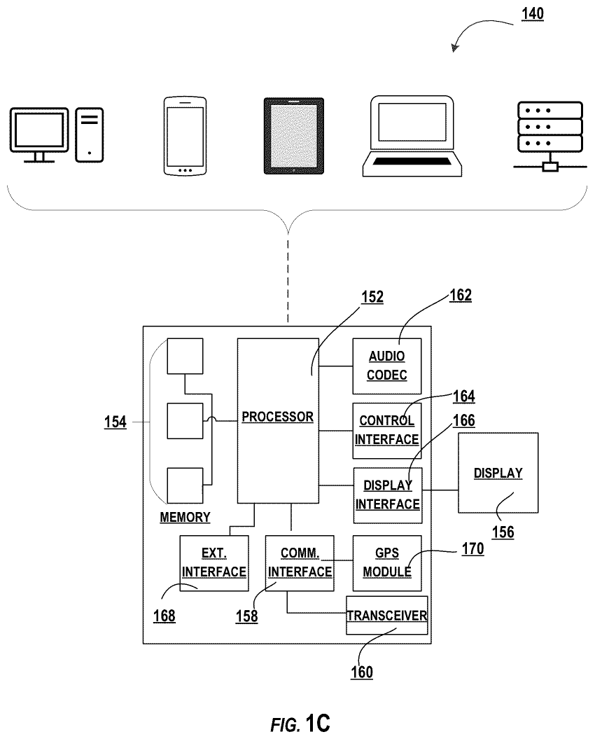

FIGS. 1A-1C illustrate technical components of an exemplary distributed computing environment 100 for amalgamation of multi-modal AI platform data via digital DNA synthesis and analysis to prevent discrepancies, in accordance with an implementation of the disclosure. As shown in FIG. 1A, the distributed computing environment 100 contemplated herein may include a system 130, an endpoint device(s) 140, and a network 110 over which the system 130 and endpoint device(s) 140 communicate therebetween. FIG. 1A illustrates only one example of an implementation of the distributed computing environment 100, and it will be appreciated that in other implementations one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some implementations, the system 130 and the endpoint device(s) 140 may have a client-server relationship in which the endpoint device(s) 140 are remote devices that request and receive application from a centralized server, i.e., the system 130. In some other implementations, the system 130 and the endpoint device(s) 140 may have a peer-to-peer relationship in which the system 130 and the endpoint device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The endpoint device(s) 140 may represent various forms of electronic devices, including user input devices such as personal digital assistants, cellular telephones, smartphones, laptops, desktops, and/or the like, input devices such as resource transfer terminals, electronic resource transfer units, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. In addition to shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an implementation of the disclosure. As shown in FIG. 1B, the system 130 may include a processing device 102, memory 104, input/output (I/O) device 116, and a storage device 106. The system 130 may also include a high-speed interface 108 connecting to the memory 104, and a low-speed interface 112 connecting to a low-speed bus 114 and a storage device 106. Each of the components 102, 104, 108, 110, and 112 may be operatively coupled to one another using various buses and may be mounted on a common motherboard or in other manners as appropriate. As described herein, the processing device 102 may include a number of subsystems to execute the portions of processes described herein. Each subsystem may be a self-contained component of a larger system (e.g., system 130) and capable of being configured to execute specialized processes as part of the larger system.

The processing device 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processing devices, along with multiple memories, and/or I/O devices, to execute the processes described herein. In other words, as used herein, a “processing device” means one processing device (e.g., a microprocessor) that performs the defined functions or a plurality of processing devices (e.g., microprocessors) that collectively perform defined functions such that the execution of the individual defined functions may be divided amongst such processing devices.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly implemented in an information carrier. The computer program product may also contain instructions that, when executed, perform one or more methods, such as those described above. The information carrier may be a non-transitory computer-or machine-readable storage medium, such as the memory 104, the storage device 106, or memory on processing device 102.

The high-speed interface 108 manages bandwidth-intensive operations for the system 130, while the low-speed controller 112 manages lower bandwidth-intensive operations. Such allocation of functions is exemplary only. In some implementations, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the endpoint device(s) 140, in accordance with an implementation of the disclosure. As shown in FIG. 1C, the endpoint device(s) 140 includes a processing device 152, memory 154, an input/output device such as a display 156, a communication interface 158, and a transceiver 160, among other components. The endpoint device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processing device 152 is configured to execute instructions within the endpoint device(s) 140, including instructions stored in the memory 154, which in one implementation includes the instructions of an application that may perform the functions disclosed herein, including certain logic, data processing, and data storing functions. The processing device may be implemented as a chipset of chips that include separate and multiple analog and digital processors. The processing device may be configured to provide, for example, for coordination of the other components of the endpoint device(s) 140, such as control of user interfaces, applications run by endpoint device(s) 140, and wireless communication by endpoint device(s) 140.

The processing device 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processing device 152. In addition, an external interface 168 may be provided in communication with processing device 152, so as to enable near area communication of endpoint device(s) 140 with other devices. External interface 168 may provide, for example, for wired communication in some implementations, or for wireless communication in other implementations, and multiple interfaces may also be used.

The memory 154 stores information within the endpoint device(s) 140. The memory 154 can be implemented as one or more of a computer-readable medium or media, a volatile memory unit or units, or a non-volatile memory unit or units. Expansion memory may also be provided and connected to endpoint device(s) 140 through an expansion interface (not shown), which may include, for example, a SIMM (Single In Line Memory Module) card interface. Such expansion memory may provide extra storage space for endpoint device(s) 140 or may also store applications or other information therein. In some implementations, expansion memory may include instructions to carry out or supplement the processes described above and may include secure information also. For example, expansion memory may be provided as a security module for endpoint device(s) 140 and may be programmed with instructions that permit secure use of endpoint device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly implemented in an information carrier. The computer program product contains instructions that, when executed, perform one or more methods, such as those described herein. The information carrier is a computer-or machine-readable medium, such as the memory 154, expansion memory, memory on processing device 152, or a propagated signal that may be received, for example, over transceiver 160 or external interface 168.

In some implementations, the user may use the endpoint device(s) 140 to transmit and/or receive information or commands to and from the system 130 via the network 110. Any communication between the system 130 and the endpoint device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the endpoint device(s) 140 may provide the system 130 (or other client devices) permissioned access to the protected resources of the endpoint device(s) 140, which may include a GPS device, an image capturing component (e.g., camera), a microphone, and/or a speaker.

The endpoint device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to endpoint device(s) 140, which may be used as appropriate by applications running thereon, and in some implementations, one or more applications operating on the system 130.

The endpoint device(s) 140 may also communicate audibly using audio codec 162, which may receive spoken information from a user and convert the spoken information to usable digital information. Audio codec 162 may likewise generate audible sound for a user, such as through a speaker, e.g., in a handset of endpoint device(s) 140. Such sound may include sound from voice telephone calls, may include recorded sound (e.g., voice messages, music files, etc.) and may also include sound generated by one or more applications operating on the endpoint device(s) 140, and in some implementations, one or more applications operating on the system 130.

Various implementations of the distributed computing environment 100, including the system 130 and endpoint device(s) 140, and techniques described here can be realized in digital electronic circuitry, integrated circuitry, specially designed ASICs (application specific integrated circuits), computer hardware, firmware, software, and/or combinations thereof.

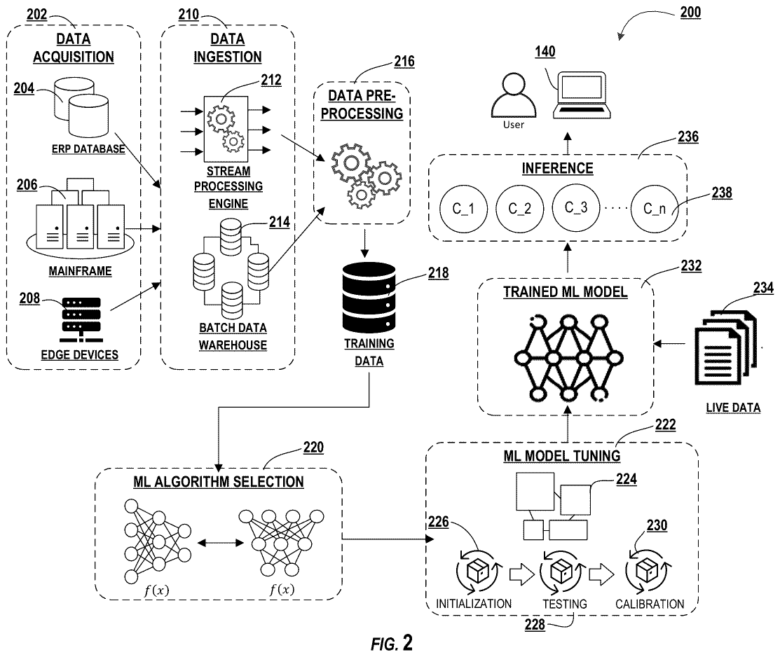

FIG. 2 illustrates an exemplary machine learning model subsystem architecture 200, in accordance with an implementation of the disclosure. The machine learning subsystem 200 may include a data acquisition engine 202, data ingestion engine 210, data pre-processing engine 316, machine learning model tuning engine 222, and inference engine 236.

The data acquisition engine 202 may identify various internal and/or external data sources to generate, test, and/or integrate new features for training the machine learning model. These internal and/or external data sources 204, 206, and 208 may be initial locations where the data originates or where physical information is first digitized. The data acquisition engine 202 may identify the location of the data and describe connection characteristics for access and retrieval of data. In some implementations, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other applications. In some implementations, the these data sources 204, 206, and 208 may include Enterprise Resource Planning (ERP) databases or protocol databases that host data related to day-to-day enterprise activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of network resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points. As will be understood in view of the present disclosure, training data 218 may additionally, or alternatively, be provided from a third party, having been generated as synthetic data.

The machine learning model tuning engine 222 may be used to train a machine learning model to form a trained machine learning model 232 using the training data 218 to make predictions or decisions without explicitly being programmed to do so. The machine learning model 232 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms can adjust their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the machine learning model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the machine learning model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical enterprise decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It shall be understood that the implementation of the machine learning subsystem 200 illustrated in FIG. 2 is exemplary and that other implementations may vary. As another example, in some implementations, the machine learning subsystem 200 may include more, fewer, or different components.

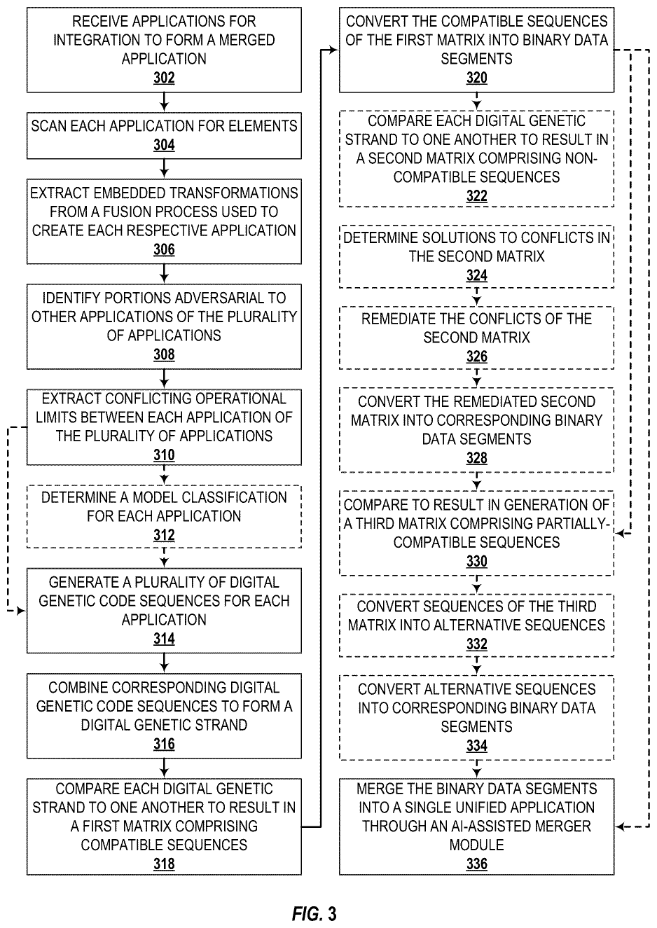

FIG. 3 illustrates a process flow for amalgamation of multi-modal AI platform data via digital DNA synthesis and analysis to prevent discrepancies, in accordance with implementations of the disclosure. The process may begin at block 302, where the system receives a plurality of applications for integration to form a merged application. When two or more entities merge, it may be desired to consolidate respective models (i.e., multi-modal AI models) into a single, merged multi-modal AI model. As used herein, an “application” may refer to any software, system, or platform designed to perform specific tasks, processes, or operations, including but not limited to a multi-modal AI application (i.e., an AI/ML model) capable of processing and integrating data from multiple input modes such as text, image, audio, or video. In addition to the multi-modal AI application, an application may include additional software programs, web-based platforms, mobile applications, cloud-based services, or any combination thereof.

Reference may be made herein to a “plurality of applications.” Alternatively, portions of the present disclosure may refer to a “first application” and a “second application” for ease of understanding of the technical processes described herein. Indeed, the systems, processes, and computer program products may apply to a first application (e.g., a first application containing a multi-modal AI application) merging with a second application (e.g., a second application containing a multi-modal AI application). However, it is contemplated that the systems, processes, and computer program products described herein may also apply to scenarios where it is intended for three or more applications to merge. Such merging may be accomplished using a recursive process, wherein a series of mergers is performed, each involving two applications, with a single application being merged into an aggregated application, in accordance with the steps outlined herein, repetitiously (i.e., one-by-one) until all applications are fully merged. Alternatively, it is contemplated that the merging of three or more applications may occur simultaneously in a single process that aggregates all applications at once.

The system may receive the plurality of through one or more means, including, but not limited to, a direct data transfer via a network connection, such as through an application programming interface (“API”), a file transfer protocol (“FTP”), or a cloud-based upload service, downloading or streaming of the application from a remote server or repository, physical media, such as a USB drive or optical disc, a peer-to-peer connection, such as through a Bluetooth or local Wi-Fi transfer.

At block 304, the system may scan each application of the plurality of applications for elements. As used herein, an “element” may refer to code, tensors, APIs, vector databases, fusion modules, resource managers, or the like. Code may implement the multi-modal AI application, manage data pipelines, and orchestrate system operations. Tensors are multidimensional arrays that represent data, serving as inputs, intermediate computations, and outputs in the multi-modal AI application. APIs act as interfaces for communicating with external systems or other parts of the application, allowing input submission and output retrieval from the multi-modal AI application. Vector databases store embeddings, which are numerical representations of data generated by the multi-modal AI application. Fusion modules combine multiple data modalities such as text, images, or audio into combined representations. Resource managers handle the allocation and optimization of computational resources, such as memory, GPUs, and CPUs, or the like.

To scan for such elements, the system may examine the codebase for files and frameworks that define the application, data processing, application logic, or the like. For example, tensors may be identified by tracing data structures and operations within the code. API(s) may be detected by analyzing endpoints, routes, and/or communication protocols. Vector databases may be identified by scanning for integrations with storage systems that handle high-dimensional embeddings. Fusion modules may be detected by analyzing dependencies, pipelines, and/or code patterns that combine multiple input modalities (e.g., text, images, or audio). Resource managers may be identified by inspecting infrastructure configurations or containerization technologies.

Next, at block 306, the system may extract embedded transformations from a fusion process used to create each application. Multi-modal systems may combine heterogeneous inputs to generate complex outputs, such as integrating video footage, textual claims, and image files for real estate evaluations. At block 306, the system may reverse engineer the fusion mechanisms used in the first and second applications to identify the techniques and processes that integrate the data sources.

To do so, using metaheuristic techniques, the system may explore the solution space to determine the specific fusion methodologies applied at various stages. The fusion process may involve techniques such as early fusion, where data is combined at the input level, late fusion, where application outputs are merged, or hybrid fusion, which combines aspects of both. The system may examine both the acquiring side, where raw data is captured, and the incoming side, where integration occurs, to identify how the fusion was achieved. By analyzing patterns, dependencies, and correlations in the fused outputs, the system may reconstruct (i.e., reverse engineer) the sequence of operations.

Continuing at block 308, the system may identify portions of each application adversarial to other applications (e.g., portions of the first application adversarial to the second application, or vice-versa).

Application portions that are “adversarial,” may, for example, refer to portions that can manipulate and deceive the multi-modal AI application by creating inputs that makes the multi-modal AI application misinterpret data. An adversarial portion of a multi-modal AI application may manipulate the input data to force the other application to make incorrect predictions or release sensitive information. Thus, prior to merging two or more applications, it is beneficial to determine if any of the two or more applications contains such abilities.

To do so, the system may implement a Tensor-based Gated Graph Neural Network (“TGGNN”). The TGGNN may model relationships between input data points as a graph, where nodes represent individual data entities or features, and edges represent relationships or dependencies between these nodes. The tensor-based structure allows the system to process complex, multi-dimensional data efficiently. The gated mechanism introduces learnable control units, which may be implemented as gating functions, which regulate the flow of information through the network. These gates may allow the model to selectively prioritize relevant relationships and suppress irrelevant or misleading information. By applying this framework, the system can analyze the interactions between different components of the applications and detect patterns indicative of adversarial behavior. Specifically, the TGGNN can identify manipulated input pathways or data dependencies that are inconsistent with expected behavior, thereby isolating adversarial portions.

In some implementations, a Generative Adversarial Network (“GAN”) may be used for detecting malicious data within the application(s). The GAN may include two or more neural networks, a generator and a determinator, that have been trained in a competitive framework. The generator may produce synthetic data that mimics the distribution of the input data, while the determinator may evaluate both real and synthetic data to distinguish between them. In doing so, the system may identify malicious data by training the determinator to detect anomalies or irregularities within the data distribution. The generator, in turn, may continuously improve its synthetic data generation such as to improve detection accuracy.

At block 310, the system may extract conflicting operational limits between each application. To do so, the system may implement multi-dimensional slicing. “multi-dimensional slicing” may refer to the process of extracting specific subsets of data from multi-dimensional data structures, such as matrices, tensors, or multi-dimensional arrays. Multi-dimensional slicing may allow for access to particular regions of the data by specifying indices, ranges, or steps along each dimension. For example, in a 3-dimensional array, slicing may retrieve a sub-array spanning a specific range of rows, columns, and depth layers.

In the present context, each application may generate multi-dimensional data, with dimensions corresponding to input features, environmental conditions, output predictions, resource usage, performance metrics (e.g., latency, accuracy, energy consumption), or the like. The system may identify and slice subsets of data that represent these parameters under similar or overlapping operational conditions for both applications. By defining slicing parameters along shared dimensions, such as workload intensity or other specific resource constraints such as memory usage, computational power, or the like, data may be extracted that reflects the behavior of each application under equivalent conditions.

Once the sliced data subsets are obtained, statistical or machine learning techniques may be used to identify potential conflicts. For example, these statistical or machine learning techniques may determine whether one application consistently shows a higher resource demand or degrades in accuracy under conditions where the other operates in a more stable manner.

Furthermore, interdependencies between parameters of the applications may be evaluated by the multi-dimensional slicing. For example, data across two dimensions of each application may be sliced (e.g., input size and processing time). In doing so, it may be determined whether increasing input size impacts one application more significantly than the other. As such, if such trends are observed (e.g., by a machine learning model or the like), it may indicate conflicting operational limits (i.e., “guardrails”)

In some implementations, the process may continue at block 312, where the system determines a model classification for each of the applications. To do so, a model classifier may be used. It shall be appreciated that the applications being merged may be different in that they are structured to generate different types of outputs. For example, the first application may be an application designed to process image data and generate visual outputs, such as edited images or graphical representations, while the second application may be configured to process text data and generate textual outputs, such as summaries or translations. The model classifier may analyze the characteristics of each application, including input types, processing capabilities, and output formats, to assign each application a classification label. It shall be appreciated that merging the first application and the second application may present challenges based on the different classifications therebetween. Such challenges may arise from differences in data structures, processing algorithms, and output requirements between the applications. For example, the first application may rely on image matrices and graphical rendering techniques, whereas the second application may depend on linguistic models and text-based processing.

In some implementations, the model classification may occur prior to other processing steps described herein, for example prior to block 304 or the like. Indeed, the present disclosure embraces numerous steps which could be performed in many different temporal arrangements, and not necessarily in the sequential order described herein or shown in FIG. 3. Furthermore, some process steps may occur in parallel to others to improve operational efficiency.

Indeed, determination of the model classification for each of the applications may be a processing step that better guides other processing steps herein, such as to select proper modules or algorithms for analysis.

At block 314, the system may generate a plurality of digital genetic code sequences for portions of each application of the plurality of applications being merged. It shall be appreciated that traditional binary code segments of the applications may be transformed into quaternary digital sequences to improve the efficiency and compactness of storage and processing. The transformation may implement quaternary encoding (i.e., using four distinct states) which provides for a higher density of information per unit compared to binary encoding. Transforming the binary code segments into quaternary digital sequences may also reduce memory requirements and improve computational throughput. Moreover, by using quaternary digital sequences, portions of each application (having been converted to the quaternary digital sequences) are more portable, modular, and separable from one another, resulting in the ability to merge the applications in a piecemeal fashion based on the determinations made throughout the rest of the present disclosure. Indeed, as used herein, a “digital genetic code sequence” may refer to one or more portions of an application that has been transformed into a quaternary digital sequence.

When subjected to the process at block 314, the system, using the quaternary encoding (for example, via a predefined mapping of binary code segments to the quaternary digital sequences), may generate digital genetic code sequences that represent at least one of: (i) the elements (as previously defined herein with respect to block 304), (ii) the embedded transformations extracted (e.g., in block 306), (iii) the portions adversarial to each other (e.g., as identified in block 308), and/or (iv) the conflicting operational limits for each respective application (e.g., as extracted in block 310). In some implementations, the system may also generate a digital genetic code sequence for each application that represents the model classification (e.g., as determined at block 312).

For example, in one implementation, a first application may be represented by a first digital genetic code sequence representing the elements of the first application, a second digital genetic code sequence representing the embedded transformations extracted, a third digital genetic code sequence representing the portions adversarial to other applications, a fourth digital genetic code sequence representing the conflicting operational limits for the application with respect to other applications, a fifth digital genetic code sequence representing the model classification of the application, and so forth. Similar digital genetic code sequences may be generated for each of the applications that is desired to be merged.

At block 316, the system may combine, for each application, corresponding digital genetic code sequences (i.e., those generated at block 314) to form a digital genetic strand. Each application may, therefore, be represented by a digital genetic strand that includes the digital genetic code sequences that relate to said application. Thus, as a result of the combining described at block 316, the process may result in a first digital genetic strand that represents the first application, a second digital genetic strand that represents the second application, and so forth, for as many applications as there are to merge.

In some implementations, in addition to the digital code sequences, the system may include in the digital genetic strand other portions of the corresponding application that are not represented by any of the digital code sequences. While such other portions may not be subject to the analysis described herein, they may be included for organizational purposes to ensure that related elements of the corresponding application are stored together within the digital genetic strand.

Continuing at block 318, the system may compare the digital genetic strands to each other. For example, a first digital genetic strand representing the first application may be compared to a second digital genetic strand that represents the second application. As a result of this comparison, digital genetic code sequences that are compatible with one another (e.g., a digital genetic code sequence of a first digital genetic strand that is compatible with a digital genetic code sequence of the second digital genetic strand) may be inserted into a first matrix, where the first matrix is configured to hold such compatible sequences.

To perform the comparison, a graph retrieval-augmented generation algorithm (“Graph RAG”) may be implemented. The Graph RAG algorithm may retrieve relevant data from a graph-based knowledge structure, such as a knowledge graph or graph database, where entities and their relationships are represented as nodes and edges, respectively. In this process, the algorithm evaluates which portions of the first digital genetic strand and the second digital genetic strand (or other digital genetic strands, depending on the implementation) meet a predefined compatibility criterion with respect to each other by analyzing their associated graph representations.

In some implementations, reference adjacency graphs may be created to represent the structural compatibility between the first application and the second application (i.e., via the first and second digital genetic strands). The adjacency graph may serve as a baseline or reference structure against which the applications evaluated. Compatibility between the two applications may be determined by analyzing whether their subgraphs or adjacency patterns align with the structure and constraints defined in the reference adjacency graph.

If the digital genetic strands exhibit acceptable alignment with the reference graph (e.g., by the predetermined criterion) they may be selected and placed into the first matrix, which serves as a structured repository. In this way, portions from each the first and second applications that are able to coexist with one another will be passed along to form the merged application (as will be described in greater detail herein).

At block 320, the system may convert the compatible sequences of the first matrix into binary data segments. In a similar manner to which the binary portions of each application were transformed into digital genetic code sequences at block 314, the portions of the digital genetic strands in the first matrix may be converted back to binary code by decoding or otherwise transforming, for further manipulation, as is described herein.

In some implementations, the process may continue at block 322, where the system, using a similar comparison technique as that of block 318 (i.e., the graph RAG algorithm) generates a second matrix of non-compatible sequences between the digital genetic strands. By isolating non-compatible portions, the system may be able to remove conflicts between these portions to facilitate merging. “Non-compatible” portions may refer to portions of the digital genetic strands that are fundamentally conflicting with each other and cannot coexist without major modification. For example, one portion of the first digital genetic strand might depend on a variable being incremented, while a portion of the second digital genetic strand decrements it within the same context.

Next, at block 324, the system may determine solutions to the conflicts within the second matrix (i.e., incompatibilities). To do so, one or more genetic algorithms having fitness and selection functions may be implemented. The fitness function may evaluate how well a given configuration reduces or eliminates conflicts. The fitness function may assign demerits based on the severity and type of conflicts (e.g., conflicts of logical incompatibilities, dependency challenges, resource usage, or the like). A scoring mechanism may quantify the total conflict demerits, such as summing weighted conflicts where high-priority conflicts contribute more to the fitness score.

The selection function may identify configurations most likely to contribute to improved solutions in subsequent iterations. Techniques like fitness proportional selection (i.e., roulette wheel selection), tournament selection, or rank-based selection may be used to prioritize configurations with fewer conflicts. Elitism techniques may preserve top-performing configurations. Other selection techniques may include linear rank selection, exponential rank selection, steady state selection, tournament selection, truncation selection, Boltzmann selection, or the like.

The foregoing determining of solutions may result in the process continuing at block 326, where the system remediates the conflicts of the second matrix through the solutions to the conflicts. The fitness and selection functions favor configurations that exhibit fewer conflicts while, in some implementations, introducing variety through crossover and mutation. In doing so in an iterative process, the system may refine the second matrix toward a state with minimal or no conflicts.

At block 328, the system may convert the non-compatible sequences of the second matrix into corresponding binary data segments. In a similar manner to which the binary portions of each application were transformed into digital genetic code sequences at block 314, the portions of the digital genetic strands in the second matrix may be converted back to binary code by decoding or otherwise transforming, for further manipulation, as is described herein.

In some implementations, the process may continue at block 330, where the system, using a similar comparison technique as that of block 318 (i.e., the graph RAG algorithm) generates a third matrix having partially-compatible sequences. “Partially-compatible” sequences refers to portions of the digital genetic strands that conflict under specific conditions but can coexist if adjusted or contextualized appropriately. In some implementations, these conflicts might involve resource contention, where both portions of the digital genetic strands rely on the same resource but at different times or overlapping logic. For example, the two applications might share similar input and processing logic but diverge in output. These partially-compatible sequences may be resolved with minor adjustments, such as reordering code, introducing synchronization mechanisms, or the like.

Indeed, at block 332, the system may convert sequences of the third matrix into alternative sequences that are more compatible with each other. To do so, a codon optimizer algorithm may be implemented. Each element within the third matrix may correspond to a triplet encoding a functional unit or instruction, with redundancy that allows multiple equivalent representations for the same function. The codon optimizer algorithm may systematically evaluate these sequences against compatibility criteria, which may include minimizing conflicts or inefficiencies, aligning patterns to a preferred operational bias, improving the overall coherence of the matrix, or the like. The codon optimizer algorithm may replace less-compatible sequences with alternatives that are both functionally equivalent and better suited to the structural or processing requirements of the third matrix. The codon optimizer algorithm iterates through the matrix to identify sequences that introduce inefficiencies and substitutes these with preferred sequences to improve interconnectivity.

At block 334, the system may convert the alternative sequences of the third matrix into corresponding binary data segments. In a similar manner to which the binary portions of each application were transformed into digital genetic code sequences at block 314, the portions of the digital genetic strands in the third matrix may be converted back to binary code by decoding or otherwise transforming, for further manipulation, as is described herein.

At block 336, the system may merge the binary data segments of the first matrix, second matrix, and third matrix, or any combination of the foregoing matrices, into a single unified application. In some implementations, redundant portions of the binary data segments corresponding to the first, second, and third matrices may first be removed. To form the single, unified application, an AI-assisted merger module may implement generative AI to combine the binary data segments of the first, second, and third matrices by generating the integration framework. In some implementations, the AI-assisted merger module may analyze the structural composition of the binary segments and construct a binary sequence that maintains the logical integrity of the binary sequences. Additionally, or alternatively, the AI-assisted merger module may synthesize supplemental linking data or indexing structures as to support the cohesive operation of the unified application.

Thus, as a result of block 336, a single framework has been developed, consolidating all tensors into a unified structure. This framework integrates modality files, encompassing video, audio, image, text, similar document types. Additionally, it may unify the vector space dimensions and embeddings into one and incorporate fusion layers, data components, and other elements, to result in the creation of a merged multi-modal application.

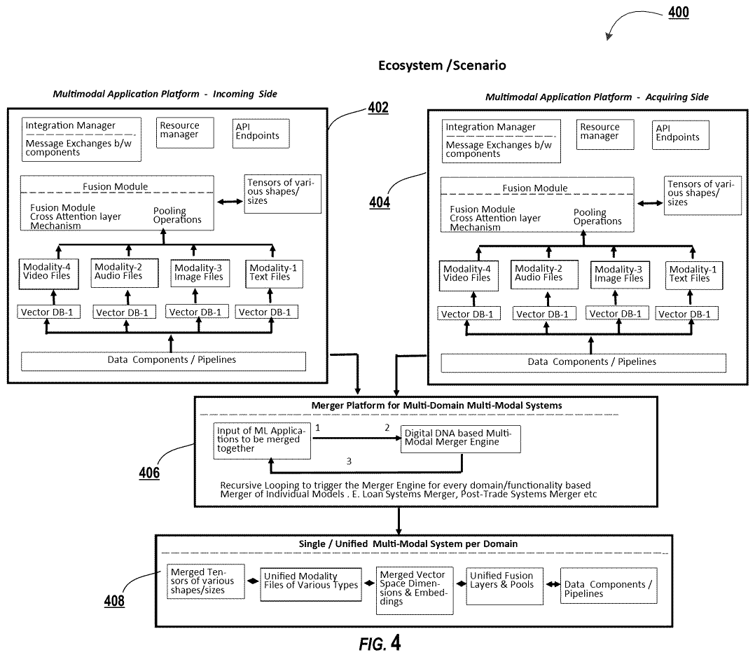

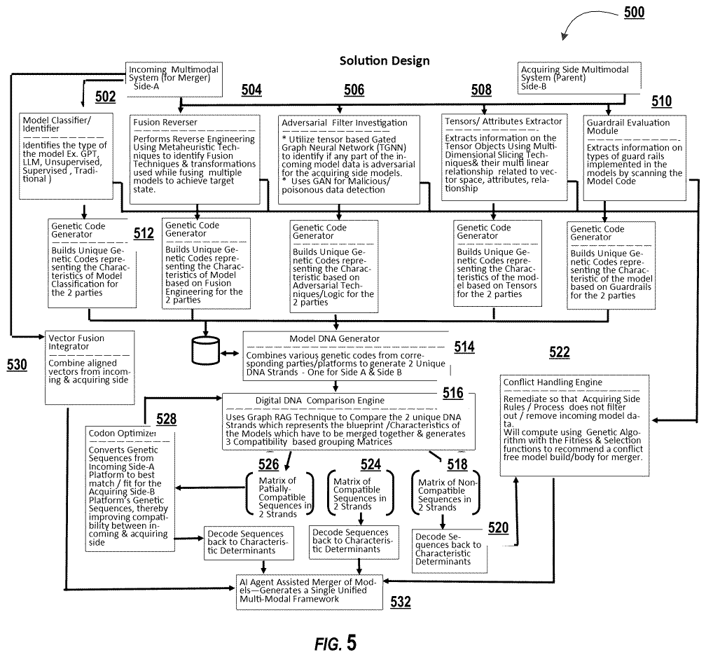

FIG. 4 illustrates a scenario ecosystem flow for amalgamation of multi-modal AI platform data via digital DNA synthesis and analysis to prevent discrepancies, in accordance with implementations of the disclosure. As previously described and discussed in detail herein, a first application 402 may be merged into a second application 404. Each of the first and second applications 402, 404 may include an integration manager, resource manager, API endpoints, tensors of various shapes and sizes, fusion module(s), video, audio, image, text files, vectors, data components and pipelines, or the like. Thus, in the implementation of FIG. 4, the first and second applications 402, 404 may be input to, or retrieved by, the merger platform 406. The merger platform 406 may include any or all of the functionalities described herein with respect to FIG. 3 and FIG. 5.

As illustrated in FIG. 4, the merger platform 406 may be used in a recursive looping process, and, for example, be triggered for multiple mergers of applications, should a given task require that multiple different types (e.g., different modalities) of applications are merged together as part of a larger project across multiple domains. As a result of using the merger platform 408, a single, unified (i.e., merged) application 408 per domain is output, where the tensors of various shapes/sizes are merged, the modality files are unified, the vector space dimensions and embeddings are merged, fusion layers and pools are unified, and/or data components/pipelines unified.

FIG. 5 illustrates an alternative process flow for amalgamation of multi-modal AI platform data via digital DNA synthesis and analysis to prevent discrepancies, in accordance with implementations of the disclosure. To begin, the system may receive a plurality of applications (e.g., a first application 402 and a second application 404) for integration to form a merged application. At block 502, the system may determine a model classification for each of the applications. At block 504, the system may extract embedded transformations from a fusion process used to create each application and reverse engineer the fusion mechanisms used in the first and second applications to identify the techniques and processes that integrate the data sources. At block 506, the system may identify portions of each application adversarial to the other applications. At block 508, the system may scan each application of the plurality of applications for elements. At block 510, the system may extract conflicting operational limits between each application. At block 512, the system may generate a plurality of digital genetic code sequences for portions of each application of the plurality of applications being merged. At block 514, the system may combine, for each application, corresponding digital genetic code sequences to form a digital genetic strand. At block 516, the system may compare the digital genetic strands to each other. At block 518, the system may generate a matrix (i.e., a “second matrix”) of non-compatible sequences between the digital genetic strands. At block 522, the system may determine solutions to the conflicts within the second matrix (i.e., incompatibilities). The system may remediate the conflicts of the second matrix through the solutions to the conflicts. At block 524, the system may generate a matrix (i.e., a “first matrix”) of compatible sequences between the digital genetic strands. At block 526, the system may generate a third matrix having partially-compatible sequences. At block 520, the system may convert the non-compatible sequences of the first, second, and/or third matrix into corresponding binary data segments. At block 528, the system may convert sequences of the third matrix into alternative sequences that are more compatible with each other. To do so, a codon optimizer algorithm may be implemented. At block 530, the system may use a vector fusion integrator to combine aligned vectors for each of the applications. At block 532, the system may merge the binary data segments of the first matrix, second matrix, and third matrix, or any combination of the foregoing matrices, into a single unified application.

As will be appreciated by one of ordinary skill in the art, the present disclosure may be implemented as an apparatus (including, for example, a system, a machine, a device, a computer program product, and/or the like), as a method (including, for example, an enterprise process, a computer-implemented process, and/or the like), as a computer program product (including firmware, resident software, micro-code, and the like), or as any combination of the foregoing. Many modifications and other implementations of the present disclosure set forth herein will come to mind to one skilled in the art to which these implementations pertain having the benefit of the teachings presented in the foregoing descriptions and the associated drawings. Although the Figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system for amalgamation of multi-modal AI platform data via digital DNA synthesis and analysis to prevent discrepancies, the system comprising:
a processing device; and
a non-transitory storage device containing instructions, when executed by the processing device, the instructions cause the processing device to perform the steps of:
receiving a plurality of applications for integration to form a merged application, wherein each application of the plurality of applications comprises a corresponding multi-modal AI application;
scanning each application of the plurality of applications for elements, wherein the elements are selected from the group consisting of code, tensors, APIs, vector databases, fusion modules, and resource managers;
extracting, for each application of the plurality of applications, by using a metaheuristic algorithm, embedded transformations from a fusion process used to create each respective application;
identifying, in each application of the plurality of applications, by using a Tensor-based Gated Graph Neural Network, portions adversarial to other applications of the plurality of applications;
extracting, from each application of the plurality of applications, by using multi-dimensional slicing, conflicting operational limits between each application of the plurality of applications;
generating a plurality of digital genetic code sequences for each application of the plurality of applications, the plurality of digital genetic code sequences comprising digital code sequences representing the elements, the embedded transformations, the portions adversarial to each other, and the conflicting operational limits for each respective application;
combining, for each application of the plurality of applications, corresponding digital genetic code sequences to form a digital genetic strand representing each respective application, resulting in a plurality of digital genetic strands;
comparing, using a graph retrieval-augmented generation algorithm, each digital genetic strand of the plurality of genetic strands to one another to result in generation of a first matrix comprising compatible sequences;
converting the compatible sequences of the first matrix into binary data segments; and
merging the binary data segments into a single unified application through an AI-assisted merger module.

2. The system of claim 1, wherein the instructions further cause the processing device to perform the steps of:
comparing, using the graph retrieval-augmented generation algorithm, each digital genetic strand of the plurality of genetic strands to one another to result in generation of a second matrix comprising non-compatible sequences;
determining, through genetic algorithms comprising fitness and selection functions, solutions to conflicts in the second matrix;
remediating the conflicts of the second matrix through the solutions to the conflicts; and
converting the remediated second matrix into corresponding binary data segments.

3. The system of claim 1, wherein the instructions further cause the processing device to perform the steps of:
comparing, using the graph retrieval-augmented generation algorithm, each digital genetic strand of the plurality of genetic strands to one another to result in generation of a third matrix comprising partially-compatible sequences;
converting, using a codon optimizer algorithm, sequences of the third matrix into alternative sequences that are more compatible with the sequences in the first and second digital genetic strands; and
converting the alternative sequences of the third matrix into corresponding binary data segments.

4. The system of claim 1, wherein generating the corresponding digital genetic code sequences includes applying a predefined mapping of binary code segments to quaternary digital sequences.

5. The system of claim 1, wherein comparing, using the graph retrieval-augmented generation algorithm, each digital genetic strand to one another comprises constructing reference adjacency graphs identify compatible sequences.

6. The system of claim 1, wherein the instructions further cause the processing device to perform the steps of:
determining, using a model classifier, a model classification for each application of the plurality of applications; and
generating a digital genetic code sequence for each application of the plurality of applications representing the model classification.

7. The system of claim 6, wherein each digital genetic strand of the plurality of digital genetic strands comprises a respective digital genetic code sequence representing the model classification for the respective application.

8. A computer program product for amalgamation of multi-modal AI platform data via digital DNA synthesis and analysis to prevent discrepancies, the computer program product comprising a non-transitory computer-readable medium comprising code causing an apparatus to:
receive a plurality of applications for integration to form a merged application, wherein each application of the plurality of applications comprises a corresponding multi-modal AI application;
scan each application of the plurality of applications for elements, wherein the elements are selected from the group consisting of code, tensors, APIs, vector databases, fusion modules, and resource managers;
extract, for each application of the plurality of applications, by using a metaheuristic algorithm, embedded transformations from a fusion process used to create each respective application;
identify, in each application of the plurality of applications, by using a Tensor-based Gated Graph Neural Network, portions adversarial to other applications of the plurality of applications;
extract, from each application of the plurality of applications, by using multi-dimensional slicing, conflicting operational limits between each application of the plurality of applications;
generate a plurality of digital genetic code sequences for each application of the plurality of applications, the plurality of digital genetic code sequences comprising digital code sequences representing the elements, the embedded transformations, the portions adversarial to each other, and the conflicting operational limits for each respective application;
combine, for each application of the plurality of applications, corresponding digital genetic code sequences to form a digital genetic strand representing each respective application, resulting in a plurality of digital genetic strands;
compare, using a graph retrieval-augmented generation algorithm, each digital genetic strand of the plurality of genetic strands to one another to result in generation of a first matrix comprising compatible sequences;
convert the compatible sequences of the first matrix into binary data segments; and
merge the binary data segments into a single unified application through an AI-assisted merger module.

9. The computer program product of claim 8, wherein the code further causes the apparatus to:
compare, using the graph retrieval-augmented generation algorithm, each digital genetic strand of the plurality of genetic strands to one another to result in generation of a second matrix comprising non-compatible sequences;
determine, through genetic algorithms comprising fitness and selection functions, solutions to conflicts in the second matrix;
remediate the conflicts of the second matrix through the solutions to the conflicts; and
convert the remediated second matrix into corresponding binary data segments.

10. The computer program product of claim 8, wherein the code further causes the apparatus to:
compare, using the graph retrieval-augmented generation algorithm, each digital genetic strand of the plurality of genetic strands to one another to result in generation of a third matrix comprising partially-compatible sequences;
convert, using a codon optimizer algorithm, sequences of the third matrix into alternative sequences that are more compatible with the sequences in the first and second digital genetic strands; and
convert the alternative sequences of the third matrix into corresponding binary data segments.

11. The computer program product of claim 8, wherein generating the corresponding digital genetic code sequences includes applying a predefined mapping of binary code segments to quaternary digital sequences.

12. The computer program product of claim 8, wherein comparing, using the graph retrieval-augmented generation algorithm, each digital genetic strand to one another comprises constructing reference adjacency graphs identify compatible sequences.

13. The computer program product of claim 8, wherein the code further causes the apparatus to:
determine, using a model classifier, a model classification for each application of the plurality of applications; and
generate a digital genetic code sequence for each application of the plurality of applications representing the model classification.

14. The computer program product of claim 13, wherein each digital genetic strand of the plurality of digital genetic strands comprises a respective digital genetic code sequence representing the model classification for the respective application.

15. A method for amalgamation of multi-modal AI platform data via digital DNA synthesis and analysis to prevent discrepancies, the method comprising:
receiving a plurality of applications for integration to form a merged application, wherein each application of the plurality of applications comprises a corresponding multi-modal AI application;
scanning each application of the plurality of applications for elements, wherein the elements are selected from the group consisting of code, tensors, APIs, vector databases, fusion modules, and resource managers;
extracting, for each application of the plurality of applications, by using a metaheuristic algorithm, embedded transformations from a fusion process used to create each respective application;
identifying, in each application of the plurality of applications, by using a Tensor-based Gated Graph Neural Network, portions adversarial to other applications of the plurality of applications;
extracting, from each application of the plurality of applications, by using multi-dimensional slicing, conflicting operational limits between each application of the plurality of applications;
generating a plurality of digital genetic code sequences for each application of the plurality of applications, the plurality of digital genetic code sequences comprising digital code sequences representing the elements, the embedded transformations, the portions adversarial to each other, and the conflicting operational limits for each respective application;
combining, for each application of the plurality of applications, corresponding digital genetic code sequences to form a digital genetic strand representing each respective application, resulting in a plurality of digital genetic strands;
comparing, using a graph retrieval-augmented generation algorithm, each digital genetic strand of the plurality of genetic strands to one another to result in generation of a first matrix comprising compatible sequences;
converting the compatible sequences of the first matrix into binary data segments; and
merging the binary data segments into a single unified application through an AI-assisted merger module.

16. The method of claim 15, wherein the method further comprises:
comparing, using the graph retrieval-augmented generation algorithm, each digital genetic strand of the plurality of genetic strands to one another to result in generation of a second matrix comprising non-compatible sequences;
determining, through genetic algorithms comprising fitness and selection functions, solutions to conflicts in the second matrix;
remediating the conflicts of the second matrix through the solutions to the conflicts; and
converting the remediated second matrix into corresponding binary data segments.

17. The method of claim 15, wherein the method further comprises:
comparing, using the graph retrieval-augmented generation algorithm, each digital genetic strand of the plurality of genetic strands to one another to result in generation of a third matrix comprising partially-compatible sequences;
converting, using a codon optimizer algorithm, sequences of the third matrix into alternative sequences that are more compatible with the sequences in the first and second digital genetic strands; and
converting the alternative sequences of the third matrix into corresponding binary data segments.

18. The method of claim 15, wherein generating the corresponding digital genetic code sequences includes applying a predefined mapping of binary code segments to quaternary digital sequences.

19. The method of claim 15, wherein comparing, using the graph retrieval-augmented generation algorithm, each digital genetic strand to one another comprises constructing reference adjacency graphs identify compatible sequences.

20. The method of claim 15, wherein the method further comprises:
determining, using a model classifier, a model classification for each application of the plurality of applications; and
generating a digital genetic code sequence for each application of the plurality of applications representing the model classification.
